(19) United States
(12) Patent Application Publication
(10) Pub. No.: US 2026/0240196 A1
(43) Pub. Date: Aug. 20, 2026

(54) FROZEN DESSERT

(71) Applicant: LOTTE CO., LTD., Tokyo (JP)

(72) Inventors: Yoko ICHIMASA, Saitama (JP); Yosuke SUZUKI, Saitama (JP); Yoshihiro YOKOTA, Saitama (JP)

(73) Assignee: LOTTE CO., LTD., Tokyo (JP)

(21) Appl. No.: 19/162,653

(22) PCT Filed: Dec. 5, 2023
(86) PCT No.: PCT/JP2023/043429

§ 371 Date: Sep. 5, 2025

(30) Foreign Application Priority Data
Mar. 8, 2023 (JP) 2023-035734

(51) Int. Cl. A23G 9/42; A23G 9/38

(52) U.S. Cl. CPC A23G 9/42; A23G 9/38

(57) ABSTRACT

A frozen dessert including a pea protein and at least one selected from the group consisting of a soy milk cream and a low-fat soy milk.

### TECHNICAL FIELD

The present invention relates to a frozen dessert.

### BACKGROUND ART

In recent years, the market for plant-based frozen desserts has been expanding in the overseas market for frozen desserts, and the demand for frozen desserts using plant materials has been increasing also in Japan from the viewpoint of SDGs. Among consumers, environmentally conscious people are replacing general frozen desserts using dairy products with plant-based frozen desserts.

Regarding a plant-based frozen dessert, for example, Patent Literature 1 discloses “concentrated soy milk containing 2.5 wt % or more of carbohydrate in which a weight ratio of the carbohydrate to a protein is set to 0.4 or more” and a frozen dessert containing the concentrated soy milk for the purpose of providing concentrated soy milk, which has a well-balanced rich flavor peculiar to soy milk and original umami and richness of soy milk, and a frozen dessert containing the concentrated soy milk.

### CITATION LIST

### Patent Literature

Patent Literature 1: JP 2006-136298 A

### SUMMARY OF INVENTION

### Technical Problem

A frozen dessert using soy milk has problems such as an odor and taste peculiar to beans and a lack of body feeling and richness of the frozen dessert. Therefore, the present invention is directed to providing a frozen dessert that has solved the above problem.

### Solution to Problem

The present inventors have extensively conducted studies and resultantly found that use of a pea protein and a soy milk cream and/or a low-fat soy milk makes it possible to solve the above problem.

Note that Patent Literature 1 does not disclose the use of a pea protein in combination with a soy milk cream and/or a low-fat soy milk.

The present invention includes the following embodiments.

[1]

A frozen dessert including:
a pea protein; and
at least one selected from the group consisting of a
soy milk cream and a low-fat soy milk.
   [2]

The frozen dessert according to [1], including the pea protein, the soy milk cream, and the low-fat soy milk.

[3]

The frozen dessert according to [1] or [2], including no dairy product.

### Advantageous Effects of Invention

According to the present invention, it is possible to provide a frozen dessert that suppresses an odor and taste peculiar to beans while having excellent body feeling and richness.

### DESCRIPTION OF EMBODIMENTS

Hereinafter, embodiments of the present invention will be specifically described, but the present invention is not limited to these embodiments, and can be modified in various ways without departing from the gist thereof.

### <Frozen Dessert>

An embodiment of the present invention relates to a frozen dessert including a pea protein and at least one selected from the group consisting of a soy milk cream and a low-fat soy milk.

The frozen dessert according to this embodiment contains the pea protein, the soy milk cream, and/or the low-fat soy milk, thereby making it possible to suppress an odor peculiar to beans while having excellent body feeling and richness. The frozen dessert according to this embodiment makes it possible to avoid a bitter aftertaste peculiar to peas.

The term “frozen dessert” used herein refers to a dessert stored under freezing conditions, such as ice creams and ice sweets, and does not include a dessert stored in a chilled temperature zone, such as pudding.

The ice creams encompass ice cream, ice milk, and lacto-ice. The terms “ice creams”, “ice cream”, “ice milk”, and “lacto-ice” used herein are in accordance with the provisions of “Ministerial Ordinance Concerning Compositional Standards, etc., for Milk and Milk Products” (MHLW Ordinance No. 106 dated Aug. 8, 2018).

Specifically, the ice creams are products obtained by freezing after processing milk or food produced from milk as a raw material, or after setting milk or food produced from milk as a main raw material, and each of the products contains 3.0% or more of milk solids (except for fermented milk).

The ice cream is a product containing 15.0% or more of milk solids and 8.0% or more of milk fat.

The ice milk is a product containing 10.0% or more of milk solids and 3.0% or more of milk fat (except for the ice cream).

The lacto ice is a product containing 3.0% or more of milk solids (except for the ice cream and the ice milk).

The ice sweet is a product containing less than 3.0% of milk solids.

The frozen dessert according to this embodiment contains a pea protein, a soy milk cream, and/or a low-fat soy milk, and preferably contains a pea protein, a soy milk cream and a low-fat soy milk. The use of these components in combination makes it possible to suppress the odor and taste peculiar to beans and improve the body feeling and richness of the frozen dessert.

The pea protein is a protein contained in the peas, preferably a powdered protein separated and extracted from the peas using only water. The peas are preferably yellow peas (scientific name: Pisum sativum).

The soy milk cream is a component separated from soybean and preferably has a protein content of 3 to 8 mass % (preferably 5 to 6 mass %) and a lipid content of 10 to 15 mass % (preferably 12 to 13 mass %), and more preferably has a soy milk cream fraction obtained according to the Ultra Soy Separation (USS) manufacturing method developed by Fuji Oil Co., Ltd.

The low-fat soy milk is a component separated from soybean and preferably has a protein content of 3 to 8 mass % (preferably 5 to 6 mass %) and a lipid content of 0 to 3 mass % (preferably 0 to 1 mass %), and more preferably has a low-fat soy milk fraction obtained according to the USS manufacturing method.

The amount of the pea protein is preferably 0.1 to 5.0 mass %, more preferably 0.5 to 3.0 mass %, and still more preferably 0.5 to 1.5 mass %, based on the mass of the frozen dessert, from the viewpoint of further suppressing the odor and taste peculiar to beans and further improving the body feeling and richness of the frozen dessert.

The amount (total amount) of the soy milk cream and/or the low-fat soy milk is preferably 0.5 to 30 mass %, more preferably 5 to 25 mass %, and still more preferably 9 to 15 mass %, based on the mass of the frozen dessert, from the viewpoint of further suppressing the odor and taste peculiar to beans and further improving the body feeling and richness of the frozen dessert.

The frozen dessert according to this embodiment may contain additional components. Examples of the additional component include fats and oils (for example, plant-based fats and oils), sugars (including sugar alcohols), salts, emulsifiers, stabilizers, fragrances, coloring agents, fruit juices, dairy products, acidulants, pH adjusters, and water.

The amount of fat and oil is not particularly limited, but is preferably 0 to 20 mass %, more preferably 1 to 18 mass %, and still more preferably 5 to 15 mass %, based on the mass of the frozen dessert.

The amount of sugar is not particularly limited, but is preferably 1 to 50 mass %, more preferably 10 to 47 mass %, and still more preferably 15 to 45 mass %, based on the mass of the frozen dessert.

The frozen dessert according to this embodiment is preferably free of a dairy product, and more preferably free of an animal raw material. The frozen dessert containing no dairy product is classified as the ice sweet described above. The term “dairy product” used herein is a product derived from animal milk, and examples thereof include a product derived from cow milk.

The frozen dessert according to this embodiment may contain an ice flake. The term “ice flake” used herein refers to a piece that is added separately from the ice mix and has a length of 0.06 mm or more. Ice flakes are distinguished from ice crystals (typically 30 to 55 μm) formed by freezing water in the ice mix.

The average length of the ice flakes is preferably 0.06 to 14 mm, more preferably 0.06 to 1.7 mm, and still more preferably 0.06 to 1.0 mm. The average length of the ice flakes may be, for example, 0.10 to 1.7 mm, 0.15 to 1.7 mm, 0.10 to 1.0 mm, or 0.15 to 1.0 mm. When the average length of the ice flake falls within the above ranges, it is possible to give a smooth texture and cool feeling.

The term “length” of the ice flake used herein means a distance between two points at which a distance between any two points on the outer edge of the ice flake photographed using an optical microscope or observed with the naked eye is maximum. The term “average length” of ice flakes used herein refers to an average value of lengths of randomly selected 100 ice flakes.

The amount of ice flakes can be, for example, 10 to 80 mass %, 20 to 70 mass %, or 30 to 60 mass %, based on the mass of the frozen dessert.

### EXAMPLES

Hereinafter, the present invention will be described in more detail with reference to Examples and Comparative Examples, but the technical scope of the present invention is not limited thereto.

### <Production of Frozen Dessert>

The components shown in Table 1 below were mixed and frozen to produce a frozen dessert.

The “pea protein” described in Table 1 is a powdered protein separated and extracted from yellow peas using only water, and the amount of protein is about 85 mass %. In addition, “soy milk cream” described in Table 1 refers to a soy milk cream fraction (high-fat fraction containing many components easily compatible with fat) obtained according to the USS manufacturing method, and “low-fat soy milk” refers to a low-fat soy milk fraction (low-fat fraction containing many water-soluble components) obtained according to the USS manufacturing method.

TABLE 1

| | Comparative | Comparative | Comparative | Comparative | Exam- | Exam- | Exam- | Exam- | Exam- | Exam- |
|---|---|---|---|---|---|---|---|---|---|---|
| Raw material | Example 1 | Example 2 | Example 3 | Example 4 | ple 1 | ple 2 | ple 3 | ple 4 | ple 5 | ple 6 |
| Soy milk cream | 25 | — | — | 19 | — | 25 | 2 | 5 | 5 | 5 |
| Low-fat soy milk | — | 27 | — | 19 | 25 | — | 7 | 10 | 9 | 10 |
| Pea protein | — | — | 3 | — | 1 | 1 | 0.5 | 1.5 | 3 | 1.5 |
| Plant-based fat and oil | 12 | 14 | 10 | 10 | 13 | 12 | 10 | 10 | 10 | 7 |
| Sugar | 31 | 31 | 43 | 23 | 32 | 31 | 43 | 43 | 43 | 23 |
| Refined salt | 0.3 | 0.3 | 0.3 | 0.3 | 0.3 | 0.3 | 0.3 | 0.3 | 0.3 | 0.1 |
| Emulsifier | 0.2 | 0.2 | 0.2 | 0.2 | 0.2 | 0.2 | 0.2 | 0.2 | 0.2 | 0.1 |
| Stabilizer | 0.2 | 0.2 | 0.2 | 0.2 | 0.2 | 0.2 | 0.2 | 0.2 | 0.2 | 0.2 |
| Fragrance | 0.1 | 0.1 | 0.1 | 0.1 | 0.1 | 0.1 | 0.1 | 0.1 | 0.1 | 0.1 |
| Coloring agent | 0.1 | 0.1 | 0.1 | 0.1 | 0.1 | 0.1 | 0.1 | 0.1 | 0.1 | 0.1 |
| Blending water | 31 | 27 | 43 | 28 | 28 | 30 | 37 | 30 | 30 | 53 |
| Total | 100 | 100 | 100 | 100 | 100 | 100 | 100 | 100 | 100 | 100 |

### <Evaluation of Frozen Dessert>

Using the frozen desserts of Examples and Comparative Examples, five trained expert panelists evaluated “bean odor”, “bitter aftertaste peculiar to pea”, “body feeling”, and “equivalent richness to frozen dessert using milk”. Note that the “body feeling” is a comprehensive feeling such as elasticity when a frozen dessert is put in the mouth, viscosity when melted, texture, and smoothness of tissue. The assessment criteria for each evaluation are as follows, the results of each expert panelist are shown in Table 2, and the average value of the results is shown in Table 3.

### [Evaluation Criteria: Bean Odor]

0 points or more and less than 1 point (x): A bean odor of soybean or pea was prominently noticeable.
1 point or more and less than 1.8 points (Δ): Slight bean odor was sensed, and taste as a frozen dessert was not sensed.
1.8 points or more and less than 2.6 points (∘): A slight odor was sensed, but the odor was not noticeable.
2.6 or more points (⊙): No bean odor was sensed.

### [Evaluation Criteria: Bitter Aftertaste Peculiar to Pea]

0 points or more and less than 1 point (x): no feeling at all
1 point or more and less than 1.8 points (Δ): slightly sensed
1.8 points or more and less than 2.6 points (∘): slightly sensed but not noticeable
2.6 points or more (⊙): no feeling

### [Evaluation Criteria: Body Feeling]

0 points or more and less than 1 point (x): no body feeling, watery, and not thick
1 point or more and less than 1.8 points (Δ): slightly viscous, but more flaky and less elastic sensed by tongue than the frozen dessert using milk
1.8 points or more and less than 2.6 points (∘): slightly insufficient as compared with the frozen dessert using milk
2.6 or more points (⊙): elasticity, texture and smoothness of the tissue sensed equivalent to the frozen dessert using milk

### [Evaluation Criteria: Equivalent Richness to Frozen Dessert Using Milk]

0 points or more and less than 1 point (x): thin taste and no richness
1 point or more and less than 1.8 points (Δ): slightly thick but insufficient in taste
1.8 points or more and less than 2.6 points (∘): not as rich as the frozen dessert using milk, but satisfactory as a frozen dessert
2.6 or more points (⊙): richness sensed equivalent to that of a frozen dessert using milk

### [Evaluation Criteria: Overall Evaluation]

x: less than 5 points in total (poor in quality)
Δ: 5 points or more and less than 7.5 points in total (slightly poor in quality)
∘: 7.5 points or more and less than 10 points in total (suitable in quality)
⊙: 10 points or more in total (excellent in quality)

TABLE 2

| | | Comparative | Comparative | Comparative | Comparative | Exam- | Exam- | Exam- | Exam- | Exam- | Exam- |
|---|---|---|---|---|---|---|---|---|---|---|---|
| | | Example 1 | Example 2 | Example 3 | Example 4 | ple 1 | ple 2 | ple 3 | ple 4 | ple 5 | ple 6 |
| Bean odor | Panelist 1 | 3 | 3 | 0 | 2 | 3 | 3 | 3 | 3 | 2 | 3 |
| | Panelist 2 | 3 | 2 | 1 | 2 | 2 | 2 | 3 | 2 | 2 | 2 |
| | Panelist 3 | 2 | 3 | 1 | 2 | 2 | 1 | 2 | 2 | 1 | 2 |
| | Panelist 4 | 2 | 2 | 1 | 2 | 2 | 2 | 2 | 2 | 1 | 2 |
| | Panelist 5 | 2 | 2 | 2 | 2 | 1 | 2 | 2 | 2 | 1 | 2 |
| | Average | 2.4 | 2.4 | 1.0 | 2.0 | 2.0 | 2.0 | 2.4 | 2.2 | 1.4 | 2.2 |
| Bitter aftertaste | Panelist 1 | 3 | 3 | 0 | 3 | 2 | 2 | 3 | 2 | 1 | 3 |
| peculiar to pea | Panelist 2 | 3 | 3 | 0 | 3 | 2 | 2 | 3 | 2 | 1 | 2 |
| | Panelist 3 | 3 | 3 | 1 | 3 | 1 | 1 | 2 | 2 | 2 | 2 |
| | Panelist 4 | 3 | 3 | 1 | 3 | 2 | 2 | 3 | 3 | 1 | 2 |
| | Panelist 5 | 3 | 3 | 0 | 2 | 2 | 2 | 2 | 3 | 2 | 3 |
| | Average | 3.0 | 3.0 | 0.4 | 2.8 | 1.8 | 1.8 | 2.6 | 2.4 | 1.4 | 2.4 |
| Body feeling | Panelist 1 | 0 | 1 | 1 | 0 | 2 | 2 | 3 | 3 | 3 | 2 |
| | Panelist 2 | 1 | 0 | 1 | 1 | 2 | 3 | 3 | 3 | 3 | 3 |
| | Panelist 3 | 1 | 0 | 1 | 1 | 2 | 2 | 2 | 3 | 3 | 2 |
| | Panelist 4 | 0 | 0 | 0 | 0 | 2 | 2 | 2 | 3 | 3 | 3 |
| | Panelist 5 | 0 | 0 | 0 | 0 | 2 | 2 | 3 | 3 | 3 | 3 |
| | Average | 0.4 | 0.2 | 0.6 | 0.4 | 2.0 | 2.2 | 2.6 | 3.0 | 3.0 | 2.6 |
| Equivalent | Panelist 1 | 1 | 0 | 1 | 1 | 2 | 2 | 3 | 3 | 3 | 3 |
| richness | Panelist 2 | 1 | 0 | 1 | 0 | 1 | 2 | 2 | 3 | 3 | 3 |
| to frozen dessert | Panelist 3 | 0 | 0 | 0 | 0 | 2 | 2 | 2 | 3 | 3 | 3 |
| using milk | Panelist 4 | 0 | 0 | 1 | 1 | 2 | 2 | 3 | 3 | 3 | 3 |
| | Panelist 5 | 1 | 0 | 1 | 1 | 2 | 2 | 3 | 3 | 3 | 2 |
| | Average | 0.6 | 0.0 | 0.8 | 0.6 | 1.8 | 2.0 | 2.6 | 3.0 | 3.0 | 2.8 |

TABLE 3

| Sensory evaluation | Comparative | Comparative | Comparative | Comparative | Exam- | Exam- | Exam- | Exam- | Exam- | Exam- |
|---|---|---|---|---|---|---|---|---|---|---|
| (score notation) | Example 1 | Example 2 | Example 3 | Example 4 | ple 1 | ple 2 | ple 3 | ple 4 | ple 5 | ple 6 |
| Bean odor | 2.4 | 2.4 | 1.0 | 2.0 | 2.0 | 2.0 | 2.4 | 2.2 | 1.4 | 2.2 |
| Bitter aftertaste | 3.0 | 3.0 | 0.4 | 2.8 | 1.8 | 1.8 | 2.6 | 2.4 | 1.4 | 2.4 |
| peculiar to pea | | | | | | | | | | |
| Body feeling | 0.4 | 0.2 | 0.6 | 0.4 | 2.0 | 2.2 | 2.6 | 3.0 | 3.0 | 2.6 |
| Equivalent richness to | 0.6 | 0.0 | 0.8 | 0.6 | 1.8 | 2.0 | 2.6 | 3.0 | 3.0 | 2.8 |
| frozen dessert using milk | | | | | | | | | | |
| Overall evaluation | 6.4 | 5.6 | 2.8 | 5.8 | 7.6 | 8.0 | 10.2 | 10.6 | 8.8 | 10.0 |
| | Comparative | Comparative | Comparative | Comparative | Exam- | Exam- | Exam- | Exam- | Exam- | Exam- |
| Sensory evaluation | Example 1 | Example 2 | Example 3 | Example 4 | ple 1 | ple 2 | ple 3 | ple 4 | ple 5 | ple 6 |
| Bean odor | ◯ | ◯ | Δ | ◯ | ◯ | ◯ | ◯ | ◯ | Δ | ◯ |
| Bitter aftertaste | ⊚ | ⊚ | X | ⊚ | ◯ | ◯ | ⊚ | ◯ | Δ | ◯ |
| peculiar to pea | | | | | | | | | | |
| Body feeling | X | X | X | X | ◯ | ◯ | ⊚ | ⊚ | ⊚ | ⊚ |
| Equivalent richness to | X | X | X | X | ◯ | ◯ | ⊚ | ⊚ | ⊚ | ⊚ |
| frozen dessert using milk | | | | | | | | | | |
| Overall evaluation | Δ | Δ | X | Δ | ◯ | ◯ | ⊚ | ⊚ | ◯ | ⊚ |

1. A frozen dessert comprising:
a pea protein; and
at least one selected from the group consisting of a soy milk cream and a low-fat soy milk.

2. The frozen dessert according to claim 1, comprising the pea protein, the soy milk cream, and the low-fat soy milk.

3. The frozen dessert according to claim 1, comprising no dairy product.

4. The ice mix according to claim 2, comprising no dairy product.
